(19) United States
(12) Patent Application Publication
(10) Pub. No.: US 2009/0166277 A1
(43) Pub. Date: Jul. 2, 2009

(54) METHOD OF CLEANSING FILTRATION MEDIA AND SYSTEM THEREOF

(75) Inventor: Yasuhiro Saito, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Nihon Genryo Co., Ltd.

(21) Appl. No.: 12/401,360

(22) Filed: Mar. 10, 2009

Related U.S. Application Data
(62) Division of application No. 11/600,786, filed on Nov. 17, 2006.
Application No. 11/600,786 is a continuation-in-part of application No. 10/415,736, filed on May 2, 2003, now abandoned.

(30) Foreign Application Priority Data
Nov. 6, 2000 (JP) PCT/JP00/07764

(51) Int. Cl. C02F 1/00

(52) U.S. Cl. 210/170.01

(57) ABSTRACT

A predetermined amount of filtration sand is suctioned out in the upward direction with a pump from a filtration reservoir embedded in the ground, during a backwash cleansing operation. The suctioned filtration sand is supplied to a sand cleansing apparatus and the filtration sand is cleansed to remove contaminants. The cleansed filtration sand is retained in a retention tank. The stocked filtration sand is returned to the filtration reservoir during the backwash cleansing operation. By repeating the suctioning, cleansing, retaining and returning of the filtration sand in this manner, the filtration sand within the filtration reservoir is automatically cleansed.

### CROSS-REFERENCES TO RELATED APPLICATION

This application is a continuation-in-part application of U.S. Ser. No. 10/415,736 filed based on International application No. PCT/JP00/07764 filed on Nov. 6, 2000.

### BACKGROUND OF THE INVENTION

1. Field of the Invention

The present invention relates to a method of cleansing filtration sand of a filtration reservoir used to filter water, and to a system therefore, and particularly to a method of cleansing a portion of filtration media which is removed from filtration reservoirs partially embedded in the ground, and to a system used therefor.

2. Description of the Related Art

Water purification processes at water treatment plants involve adding chemicals to untreated water drawn from rivers, lakes, ponds, or wells to consolidate the suspended matter therein to a size that causes said consolidated matter to deposit on the bottom. The supernatant water is skimmed and sent to a filtration reservoir, where it is passed through a layer of sand (filtration sand) to remove the finer suspended matter. This water is then disinfected with chlorine. At filtration reservoirs partially embedded in the ground, regular cleansing of filtration media is performed at intervals of 24˜72 hours. As methods of cleansing the filtration media, there are: surface cleansing, in which water is sprayed from a nozzle to strike the surface of the sand layer; and backwash cleansing, in which purified water is forced into the filtration reservoir from a lower pressure chamber to cause the sand particles to rub against each other, to remove contamination.

Even if surface cleansing and backwash cleansing are regularly performed, pollutants in the water (contaminants such as sludge, hereinafter referred to as contaminants) attach to the surfaces of the filtration sand, if used for a long period of time. Problems arise from repeated use over a period of time such as: the reduction of space among the filtration media due to the progressive thickening of particle size from contaminant accumulation thereon, clogging due to the separation of materials that had been attached to the filtration media, and the leaking of the contaminants themselves. Conventionally these problems were dealt with by, for example, increasing the frequency of the backwash process. However, if the backwash process is repeated over a long period of time, the water pressure thereof influences even the gravel layer which supports the filtration media, creating areas of different thickness in said layer, which is optimally flat and of an even thickness. When the gravel layer becomes uneven, the sand layer is thin at portions where the gravel layer is thick, and insufficient filtration occurs at these portions. The filtration function is reduced, the filtration reservoir does not function properly, and the supply of safe water becomes impossible.

In order to restore proper filtration function, it is necessary to perform a regeneration process, which involves: ceasing the total operation of the filtration reservoir, removing the filtration media, cleansing and sieving the removed filtration media, inspecting and correcting the interior of the filtration reservoir, replacing the filtration media with the filtration media which has been cleansed. However, the regeneration process is extremely costly, and as during said process the filtration reservoir is not operating, it leads to a decrease in water treatment efficiency. Therefore, there is a strong demand on the part of the water treatment plant to space the intervals between regeneration processes as long as possible.

There are cases in which the filtration sand which is replaced in the course of the regeneration process is new sand. However, stringent standards are set so that the percentage of collected sand that is acceptable as filtration sand is only 10˜20% in reality. In addition, costs are increased in the case that new sand is utilized. Therefore, filtration sand is regenerated by cleansing and the like. The inventors of the present invention have proposed a sand cleansing apparatus which enables cleansing of filtration sand to a degree of contamination less than or equal to 30, which is a state of cleanliness close to that of new sand, by employing a revolutionary method called a scrubbing cleansing process as shown in U.S. Pat. Nos. 6,273,106 and 6,382,221. By use of this apparatus, filtration function similar to that of a filtration reservoir that employs new sand is capable of being realized, even if new filtration sand is not replaced in the filtration reservoir during the regeneration process.

However, the quality of water to be filtered for use is rapidly deteriorating in recent years. This is due to: pollution of rivers, lakes, and the ocean by city waste water, industrial waste water, and agricultural waste water; acid rain that includes nitrous oxides and sulfur oxides due to atmospheric pollution; and the like. Due to the deterioration in the quality of water to be filtered, contamination of the filtration sand has advanced as shown in Table 1. Filtration reservoirs which were capable of being utilized for a period of 7˜10 years under normal operating conditions must now quicken the pace of regeneration processes.

TABLE 1

| | | | Post | | | Hydrochloric | |
|---|---|---|---|---|---|---|---|
| | | | Cleansing | Dry Weight of | | Acid | Post Cleansing |
| Reservoir/ | | Contamination | Weight | Contaminants | | Solubility | Contamination |
| Year | | (degree) | (g) | (mg) | (mg/g) | (%) | (degree) |
| A | 1985 | 4340 | 48.96 | 1150 | 23.963 | 1.60 | 172 |
| | 1994 | 6830 | 48.03 | 2260 | 47.054 | 3.40 | 394 |
| B | 1986 | 3940 | 49.29 | 658 | 13.350 | 2.10 | 140 |
| | 1993 | 6340 | 48.59 | 1320 | 27.166 | 2.80 | 320 |
| C | 1987 | 4760 | 48.67 | 839 | 17.238 | 2.20 | 169 |
| | 1995 | 8380 | 48.57 | 1948 | 40.107 | 2.40 | 560 |

Meanwhile, maintenance operations of filtration sand performed at filtration reservoirs are performed to determine the time frame of the next regeneration process, and mainly involve measurement of the unevenness of the gravel layer, measurement of particle diameters, and the like. Maintenance operations to preserve the function of the sand which has regained its filtration function by the regeneration process are limited to regular cleansing processes of surface cleansing and backwash cleansing.

The degree of contamination of water, which has passed through filtration reservoirs, is desired to be less than or equal to 0.1 degree, as the result of cryptosporidium provisional measures. To comply with the requirement, water treatment plants are increasing the frequency of the surface cleansing and backwash cleansing which have been described above. However, during these cleansing operations, water cannot be treated, and the amount of obtainable water is decreased. Consequently, the water treatment efficiency is reduced. In addition, fine sand flows out every time that cleansing is performed. Further, if the frequency of backwash cleansing is increased, the formation of uneven thickness in the gravel layer is hastened. As a result, there are cases in which a regeneration process must be performed sooner. Therefore, it is thought that there are limits to the extent which conventional surface cleansing and backwash cleansing can deal with the contamination of filtration media.

As shown in U.S. Pat. No. 5,112,504, in a filtering system using a granular media bed-containing filtering vessel having a cylindrical upper portion and a conically-shaped bottom portion, it was known to wash dirty media in a separate media-washing vessel connected by line to the bottom of the conical or other sloped bottom interior of the filtering vessel. The washed media is recycled and distributed by a distributing apparatus. This is not for a filtration reservoirs partially embedded in the ground.

### BRIEF SUMMARY OF THE INVENTION

The present invention has been developed in view of the above circumstances, and it is the object of the present invention to provide a method and apparatus for cleansing filtration sand in one or a plurality of filtration reservoirs totally or partially embedded in the ground.

The filtration reservoir embedded in the ground is a special type of large filtration reservoir which filters sand at a high speed. This type of filtration reservoirs, unlike a vessel type filtration apparatus, are capable of filtering a great amount of filtered water, and can save costs of space because of their high speed of filtration operation. In order to increase the practicability of the filtration system, it is desirable to provide a plurality of filtration reservoirs embedded in the ground.

Therefore, it is the object of the present invention to provide a method and apparatus for cleansing filtration sand in at least one filtration reservoir totally or partially embedded in the ground that enables extension of the time period between regeneration processes by regenerating the filtration function of sand by a method other than by surface cleansing or backwash cleansing, without ceasing operation of the filtration reservoirs partially embedded in the ground.

The method for cleansing filtration sand in a filtration reservoir according to the present invention comprises the steps of:

suctioning out a predetermined amount of filtration sand in an upward direction from a filtration reservoir embedded in the ground during a backwash cleansing operation thereof;

supplying the extracted filtration sand to a sand cleansing apparatus;

cleansing the filtration sand to remove contaminants therefrom with the sand cleansing apparatus;

retaining the cleansed filtration sand in a retention tank positioned separately from the filtration reservoir;

returning the cleansed filtration sand to the filtration reservoir during the back wash cleansing operation thereof; and

repeating the above suctioning, supplying, cleansing, retaining and returning steps to cleanse the filtration sand of the filtration reservoir.

Another method for cleansing filtration sand in a plurality of filtration reservoirs according to the present invention comprises the steps of:

suctioning out a predetermined amount of filtration sand in an upward direction from a first filtration reservoir of a plurality of filtration reservoirs during a backwash cleansing operation of the first filtration reservoir;

supplying the extracted filtration sand to a sand cleansing apparatus;

cleansing the filtration sand to remove contaminants therefrom with the sand cleansing apparatus;

retaining the cleansed filtration sand in a retention tank positioned separately from the filtration reservoir;

returning the cleansed filtration sand to a second filtration reservoir of the plurality of filtration reservoirs during the back wash cleansing operation of the second filtration reservoir; and

repeating the above suctioning, supplying, cleansing, retaining and returning steps to cleanse the filtration sand of the filtration reservoirs.

A system for cleansing filtration sand in a filtration reservoir embedded in the ground according to the present invention comprises:

a filtration reservoir totally or partially embedded in the ground;

a suctioning means for suctioning out filtration sand in an upward direction from the filtration reservoir;

a sand cleansing apparatus for cleansing the suctioned out filtration sand;

a retention tank for receiving the cleansed filtration sand from the sand cleansing apparatus and retaining the same,

a returning means for returning the same to the filtration reservoir during a backwash cleansing operation thereof.

A system for cleansing filtration sand in a plurality of filtration reservoirs embedded in the ground according to the present invention comprises:

a plurality of filtration reservoirs;

a suctioning means for suctioning out a predetermined amount of filtration sand in an upward direction from one of the filtration reservoirs during a backwash cleansing operation of the first filtration reservoir;

a sand cleansing apparatus for cleansing the suctioned filtration sand;

a retention tank for receiving the cleansed filtration sand from the sand cleansing apparatus and retaining the same,

a returning means for returning the same to another filtration reservoir of the plurality of filtration reservoirs during a backwash cleansing operation of the second filtration reservoir.

The “filtration reservoir embedded in the ground” is a large normally rectangular filtration plant or reservoir totally or partially embedded in the ground in which the water is filtered through a filtration sand layer. It is a so-called “high speed filtration reservoir”. The filtration sand is backwashed by forcing pure water upwardly through the filtration sand layer from time to time between normal filtration operations or normal state to filter water passing downward through a filtration sand layer.

The “suctioning out of filtration sand” is performed to suction out the filtration sand in the upward directions during a backwash operation of the filtration reservoir. This is because the contaminated filtration sand can be effectively taken out of the reservoir if the suctioning out is performed during the backwash operation. If the suctioning out is carried out in a normal state wherein the filtration sand filters water, thin sand layer portions are likely to be formed in the filtration sand layer, which will cause leakage of contaminants in the normal filtering operation. The suctioning out of filtration sand may be performed when surface cleansing is being performed concurrently with the backwash cleansing operation.

The “returning of filtration sand” is also performed during the backwash operation of the filtration reservoir. This is because during the backwash cleansing operation, purified water is forced upwardly into the filtration reservoir from a lower pressure chamber, thereby causing the filtration sand therein to float. If filtration sand is returned in the filtration reservoir in this state, the filtration sand is capable of forming a flat layer when the backwash cleansing is completed. Note that the returning of filtration sand may be performed when surface cleansing is being performed concurrently with the backwash cleansing operation, in a similar manner to the extraction of filtration sand. The “predetermined amount of filtration sand” refers to an amount of filtration sand that does not affect the purification of water by the filtration reservoir.

It is also preferable that the “suctioning out of filtration sand” is performed with a suction force of a strength that does not form uneven thicknesses in the gravel layer of the filtration reservoir. The filtration sand layer in a filtration reservoir partially embedded in the ground is about 60 cm thick. In case that filtration sand is suctioned out using an excessive suction force, or filtration sand is suctioned out close to the boundary thereof with the gravel layer, the gravel layer, which supports the filtration sand, may become thinner and thicker at portions thereof. Therefore, it is preferable that suctioning out of filtration sand is performed with a suction force of a strength that does not form uneven thicknesses in the gravel layer. Although there are variances depending on the structure of the filtration layer and the suction force employed in the extraction, it is preferable that the suctioning put of filtration sand be performed at a depth from the surface of the filtration sand layer of 15˜70% of the thickness thereof. It is further preferable that the extraction of filtration sand be performed at a depth from the surface of the filtration sand layer of 40˜60% of the thickness thereof. In the case that an unevenness prevention net is utilized, suctioning out may be performed at 100% of the depth of the filtration sand layer, that is, from just above the gravel layer.

After contaminants have been removed from the filtration sand by the sand cleansing apparatus, the cleansed filtration sand is retained in a retention tank so that the cleansed filtration sand may be retained therein until the next backwash operation of the filtration reservoir to which the cleansed filtration sand is to be returned.

It is preferable that water or an oxidizing agent is contained in the retention tank so that the filtration sand retained therein does not contact air. Chlorine, for example, is preferable as the oxidizing agent. By transferring the cleansed filtration sand from the sand cleansing apparatus to the retention tank, cleansing of sand from another filtration reservoir of the plurality of filtration reservoirs is enabled, in the empty sand cleansing apparatus. By keeping water, or water including an oxidizing agent in the retention tank, the filtration sand does not dry. Thereby, the activation of a manganese layer of the filtration sand, which has the ability to remove manganese from water to be filtered, can be preserved. With regard to the size of the retention tank, a size sufficiently large enough to retain filtration sand of the predetermined amount, extracted from the filtration reservoir in one extraction operation, in water so that it is prevented from contacting air, may be adopted.

The retained filtration sand is returned to a filtration reservoir different from that from which the filtration sand has been extracted. This is because the cleansed filtration sand cannot be returned to the same filtration reservoir until the next backwash cleansing operation thereof. Therefore, essentially the same amount of time will be required as the case in which the filtration sand is cleansed for each filtration reservoir one by one. If a large retention tank is provided, retention of cleansed filtration sand which has been extracted from a plurality of filtration reservoirs would be possible. However, this would also incur large installation costs. Normally, at water treatment plants where a plurality of filtration reservoirs are connected, backwash cleansing of the filtration reservoirs is not performed simultaneously, from the viewpoint of processing capacity. Backwash cleansing is performed for each of the filtration reservoirs partially embedded in the ground at a staggered timing. By taking advantage of this staggered timing, cleansing of the filtration sand of all of the filtration reservoirs is enabled in substantially the same time as that expended in the cleansing of all of the filtration sand for one filtration reservoir, even in the case that the number of filtration reservoirs increases. In addition, as the retention tank is of the same scale as that used in the case in which filtration sand from a single filtration reservoir is cleansed, this is preferable from the viewpoint of installation costs.

At water treatment plants having a plurality of filtration reservoirs partially embedded in the ground, there are cases in which filtration reservoirs with filtration sand which is highly contaminated and filtration reservoirs with filtration sand which is relatively lightly contaminated coexist. In cases like these, it is preferable, from the viewpoint of equalization of filtration sand of the plurality of filtration reservoirs, to return filtration sand extracted from a highly contaminated filtration reservoir to a filtration reservoir which is lightly contaminated, and vice versa.

It is preferable that the repetition of each of these steps is automatically performed by sequence control. That is, because the backwash cleansing of a filtration reservoir is controllable by using pressure loss or time as factors, the steps of extraction; cleansing; and returning of the filtration sand, or the steps of extraction; cleansing; retention; and returning of the filtration sand can be automatically performed by sequence control.

Both the extraction and return of filtration sand are performed during backwash cleansing, when filtration sand is in a floating state. It is preferable that the filtration sand which has already been cleansed not be mixed in with the filtration sand to be extracted, in order to increase the cleansing efficiency. Accordingly, it is preferable that the cleansed filtration sand be returned to the filtration reservoir at a position remote from the position from which filtration sand is extracted. That is, it is preferable that the means for extracting filtration sand from the filtration reservoir and the means for returning filtration sand, from which contaminants have been removed, are provided remote from each other. It is also preferable, from the viewpoint of cleansing efficiency, that the position at which filtration sand is extracted is changed per every extraction operation, and that the position to which the cleansed filtration sand is returned is changed per every returning operation. That is, it is preferable that at least one of the means for extracting filtration sand from the filtration reservoir and the means for returning cleansed filtration sand to the filtration reservoir be provided so as to be movable.

As the “sand cleansing apparatus”, it is preferable to employ an apparatus that is disclosed in U.S. Pat. Nos. 6,273,106 and 6,382,221, which comprises: a cleansing tank for containing sand and cleansing water therein; a screw conveyor that rotates about a substantially perpendicular axis within the cleansing tank; a rotating means for rotating the screw conveyor at a speed so that: the rotation of the screw conveyor causes the sand and cleansing water to be elevated while contaminants are removed from the sand by contact between particles thereof with the cleansing water therebetween, at a lower portion of the screw conveyor which is beneath the surface of the cleansing water, and the rotation of the screw conveyor causes the sand to flow while contaminants are removed from the sand by contact between particles thereof with a slight amount of contaminant-laden water therebetween; and a circulation means for causing the elevated sand to descend to the lower portion of the screw conveyor so that the sand is elevated again.

The disclosures in U.S. Pat. Nos. 6,273,106 and 6,382,221 are incorporated herein by reference.

Whereas conventionally, cleansing of filtration sand relied solely on backwash cleansing, the method of cleansing filtration sand of the present invention extracts a predetermined amount of filtration sand from a filtration reservoir during a backwash cleansing operation thereof; supplies the extracted filtration sand to a sand cleansing apparatus; cleanses the filtration sand with the sand cleansing apparatus to remove contaminants therefrom; returns the filtration sand, from which contaminants have been removed, to the filtration reservoir during a backwash cleansing operation thereof; and repeats the extraction, cleansing, and returning of the filtration sand to cleanse the filtration sand within the filtration reservoir. Therefore, the filtration sand is enabled to be effectively cleansed without ceasing operation of the filtration reservoir, and the time period between regeneration processes can be dramatically extended.

More specifically, if substantially all of the filtration sand within a filtration reservoir is automatically cleansed by repeating the extraction, cleansing, and returning of the filtration sand, it becomes possible to restore the water purification function of the filtration reservoir. In addition, if contaminants are removed from the filtration sand, a decrease in the filtration resistance becomes possible, and backwash cleansing can be performed at pressures as designed. Accordingly, it becomes possible to reduce the leakage of filtration sand, as well as to dramatically reduce the leakage of contaminants removed therefrom. Further, it becomes possible to delay the formation of unevenness of thickness in the gravel layer. From this point also, the time period between regeneration processes can be dramatically extended.

Note that by: extracting a predetermined amount of filtration sand from a filtration reservoir during a backwash cleansing operation; supplying the extracted filtration sand to a sand cleansing apparatus; cleansing the filtration sand to remove contaminants therefrom with the sand cleansing apparatus; retaining the cleansed filtration sand in a retention tank; returning the retained filtration sand, into a filtration reservoir different from that from which the filtration sand has been extracted, during a backwash cleansing operation thereof; and repeating the above extracting, cleansing, retaining, and returning operations, the filtration sand of a plurality of filtration reservoirs can be cleansed efficiently without ceasing the operations thereof. In addition, because the filtration sand which is retained in the retention tank is returned to a filtration reservoir different from that from which the filtration sand has been extracted, cleansing of filtration sand of a plurality of filtration reservoirs is capable in substantially the same amount of time as the case in which filtration sand from a single filtration reservoir is cleansed. Further, by returning filtration sand extracted from a highly contaminated filtration reservoir to a filtration reservoir which is lightly contaminated and vice versa, equalization of the filtration sand of the filtration reservoirs can be realized.

Further, by employing a sand cleansing apparatus comprising: a cleansing tank for containing sand and cleansing water therein; a screw conveyor that rotates about a substantially perpendicular axis within the cleansing tank; a rotating means for rotating the screw conveyor at a speed so that: the rotation of the screw conveyor causes the sand and cleansing water to be elevated while contaminants are removed from the sand by contact between particles thereof with the cleansing water therebetween, at a lower portion of the screw conveyor which is beneath the surface of the cleansing water, and the rotation of the screw conveyor causes the sand to flow while contaminants are removed from the sand by contact between particles thereof with a slight amount of contaminant-laden water therebetween; and a circulation means for causing the elevated sand to descend to the lower portion of the screw conveyor so that the sand is elevated again, as the sand cleansing apparatus for the method and system for cleansing filtration sand of the present invention, contaminants can be removed without crushing the sand by the particles of sand scrubbing each other. Therefore, the water purification function of the filtration sand can be restored to a state close to that of new sand. Accordingly, the time period between regeneration processes of the filtration reservoir can be further extended.

In addition, water treatment plants have been increasing the frequency of conventional surface cleansing and backwash cleansing as a cryptosporidium measure. However, it becomes possible to maintain the degree of contamination to less than or equal to 0.1 at the exit of the filtration reservoir, while performing the surface cleansing and the backwash cleansing at normal frequency, by the method and system for cleansing filtration sand of the present invention. Therefore, the cryptosporidium measure is aided, and water treatment plants can be operated without reducing the purification efficiency.

### BRIEF DESCRIPTION OF THE DRAWINGS

FIG. 1 is a process diagram showing an embodiment of the filtration sand cleansing method of the present invention.

FIG. 2 is a schematic view showing a first embodiment of the filtration sand cleansing system of the present invention.

FIG. 3 is a schematic view showing a second embodiment of the filtration sand cleansing system of the present invention.

FIG. 4 is a sectional view of a filtration reservoir, taken along the line 4-4 of FIG. 2.

FIG. 5 is a diagram showing the flow of filtration sand corresponding to a plurality of filtration reservoirs.

FIG. 6 is a diagram that shows an example of the movement of filtration sand among filtration reservoirs.

### DETAILED DESCRIPTION OF THE INVENTION

The present invention will now be described in detail referring to drawings showing embodiments thereof. FIG. 2 shows one embodiment thereof, wherein a single filtration reservoir is employed. The filtration sand cleansing system according to the first embodiment of the invention is comprised of a filtration reservoir 1 embedded in the ground; a pump 2 for suctioning out filtration sand having contaminants attached thereto from the filtration reservoir 1 in the upward direction; a sand cleansing apparatus 3 for cleansing the filtration sand having contaminants attached thereto connected to the filtration reservoir 1 though a line 5; a stock tank 4 for stocking or retaining the cleansed filtration sand, which has been cleansed by the sand cleansing apparatus 3, connected thereto by way of line 6; and a path 7 through which the cleansed filtration sand is returned to the filtration reservoir 1 from the stock tank 4. The details of the process steps of the filtration sand cleansing system will be described later.

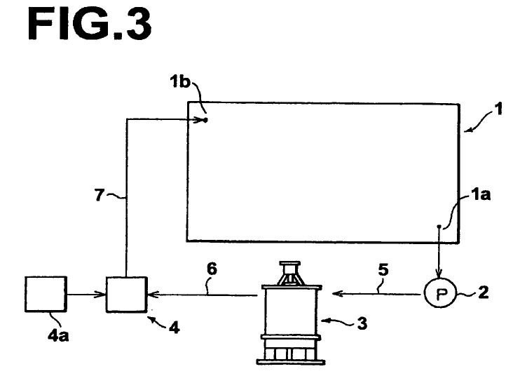

As shown in FIG. 3, the stock or retaining tank 4 may be provided with a means 4a for supplying water to the tank 4 to prevent the filtration sand within the retention tank from contacting air.

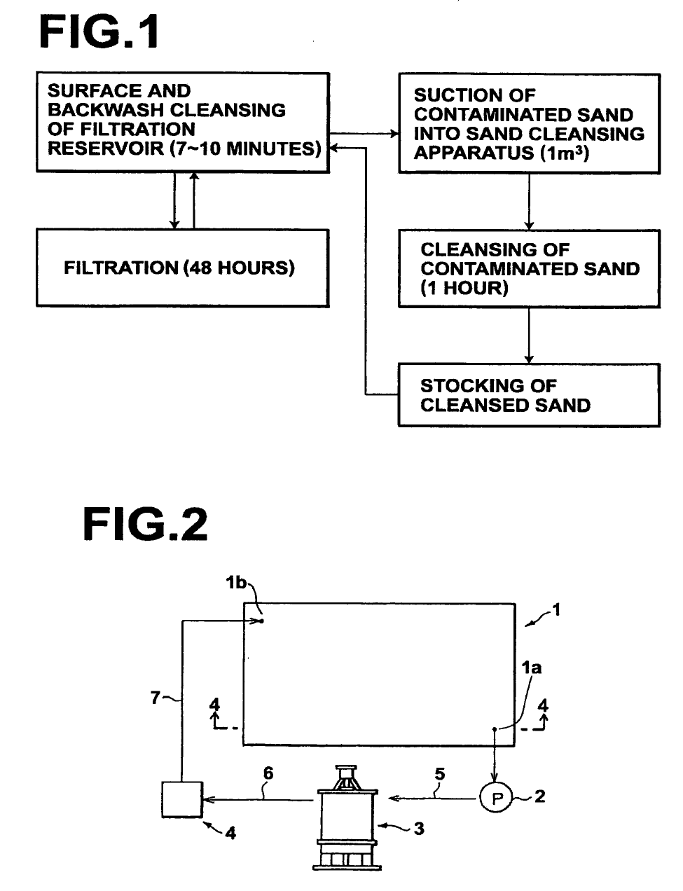

As an example of the processes performed by the filtration sand cleansing system shown in FIG. 3 is shown in FIG. 1. First, approximately 1 m³ of contaminated filtration sand is suctioned out of the filtration reservoir 1 with the pump 2 during the time (e.g., 7˜10 minutes) when surface cleansing and backwash cleansing is being performed. The filtration sand suctioned by the pump 2 is sent to the sand cleansing apparatus 3, where cleansing is performed for approximately 1 hour thereby. Then, the cleansed filtration sand is retained in the stock tank 4 until the next surface cleansing and backwash operation of the filtration reservoir 1, and then the cleansed filtration sand is returned to the filtration reservoir 1 during the next surface cleansing and backwash operation.

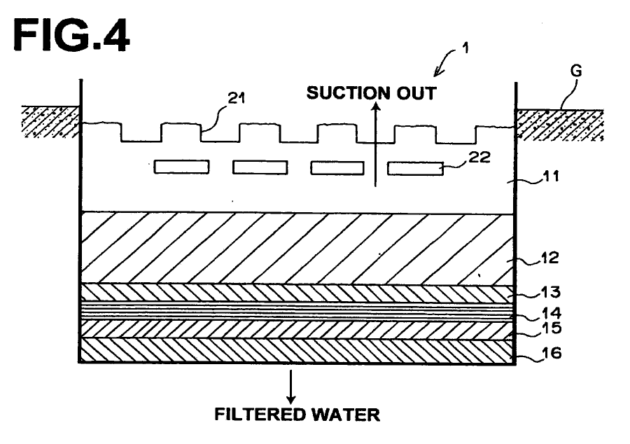

As shown in FIG. 4, the filtration reservoir 1 partially embedded in the ground G is provided with a filtration sand layer 12, which acts as a filtration layer, and gravel layers 13 through 16 for supporting the filtration sand layer 12. The filtration sand layer comprises sand having effective particle diameters of 0.6 mm, and a uniformity coefficient of less than or equal to 1.5. The gravel layers are formed of four layers having different particle diameters, and serve as supporting layers to prevent the filtration sand 12 from entering a water collection apparatus (not shown, but the apparatus for collecting purified water is provided at a still lower portion of the filtration reservoir 1). Spherical, hard, clean, and uniform gravel is selected for the gravel layers 13 through 16, in order to perform backwash cleansing uniformly. As particle diameters thereof, those which are commonly used, that is, gravel having effective particle diameters of 2.0˜3.5 mm for the gravel layer 13; gravel having effective particle diameters of 3.5˜7.0 mm for the gravel layer 14; gravel having effective particle diameters of 7.0˜13.0 mm for the gravel layer 15; and gravel having effective particle diameters of 13.0˜20.0 mm are employed for the gravel layer 16. These layers are sequentially laid with the coarser grain gravel in the lower layers and the finer grain gravel in the upper layers, and without unevenness of thicknesses thereof. Pretreated water, of which contaminants therein have been consolidated by a flocculant and caused to deposit at the bottom, is introduced above the filtration sand layer 12. In addition, a surface cleansing pipe 22, for spraying water from a nozzle to strike the surface of the filtration sand layer during surface cleansing; and a trough 21, for draining the wastewater generated during surface cleansing and backwash cleansing, are provided above the filtration sand layer 12.

Next, purification process steps commonly used for purifying untreated water will be briefly described. Untreated water is drawn into a consolidation/deposition reservoir from rivers, lakes, and the like. The contaminants in the untreated water are consolidated by adding a flocculant such as polychlorinated aluminum, and the consolidated contaminants are caused to deposit on the bottom of the consolidation/deposition reservoir. The supernatant water is skimmed and sent to the filtration reservoir 1 above the filtration sand layer 12. Fine suspended matter which was not removed in the consolidation/deposition reservoir is removed by the filtration sand 12. The filtered water is collected at the water collection apparatus (not shown) provided at the lower portion of the filtration reservoir 1. The collected water is disinfected with chlorine, and retained at a water distribution reservoir. The filtration speed is normally 120˜150 m per day. Cleansing of sand by ceasing filtration operations and forcing cleansing water from a lower pressure chamber of the filtration reservoir, thereby causing the particles of filtration sand to float and rub against each other, is performed at regular intervals, or when head loss reaches 1.5 m. It is a backwash cleansing. Surface cleansing is performed by spraying cleansing water from the surface cleansing pipe 22 onto the surfaces of the filtration sand 12, during the backwash cleansing or at a timing matched with a certain point in the backwash cycle. The wastewater generated by the surface cleansing and the backwash cleansing is drained by the trough 21. When cleansing is complete, pretreated water to be purified is again sent to the filtration reservoir, and filtration is recommenced. Normally, the water purification and sand cleansing steps are automated. Depending on the state of the untreated water to be purified at the water treatment plant with the high speed filtration method, the timing of the surface cleansing and backwash cleansing may be preset. Alternatively, the surface cleansing and backwash cleansing may be set to be automatically performed when the head loss exceeds a predetermined value.

As shown in Table 2, standards for filtration sand (Japanese Water Works Association Technical Standard JWWA A 103-1988) are established as: less than or equal to 30 degrees for post cleansing contamination degree; less than or equal to 3.5% for hydrochloric acid solubility; 0.45˜0.70 mm for effective particle diameters; and less than or equal to 1.7 for uniformity coefficient. Even if surface cleansing and backwash cleansing is performed regularly as described above and regeneration processes are performed every seven years, if ten years pass from the time when new sand is introduced, as indicated by the contaminated sand of Table 2, contaminants attach to the filtration sand to contaminate it so that the post cleansing contamination degree is 1,480 degrees, the hydrochloric acid solubility is 9.7%, the effective particle diameter is 0.533, and the uniformity coefficient is 1.485.

TABLE 2

| | Established Standards | Contaminated |
|---|---|---|
| | for Filtration Sand | Sand |
| Contamination Post Cleansing | 30 degrees or less | 1,480 degrees |
| Hydrochloric Acid Solubility | 3.5% or less | 9.7% |
| Effective Particle Diameter | 0.45-0.70 mm | 0.533 |
| Uniformity Coefficient | 1.7 or less | 1.485 |

If filtration sand to which contaminants are attached in this manner continues to be utilized, clogging due to contaminants occurs, causing rapid increases in head loss. Therefore, the frequency of backwash cleansing is increased, and the water pressure involved therewith affects the gravel layers, quickening the formation of unevenness in the thickness thereof. By the formation of unevenness in the thickness of the gravel layers, the sand layer becomes thin at the portions where the gravel layers are thick, causing insufficient filtration at these portions. In addition, breakthrough of sludge and contaminants that separate from the filtration sand occurs, negatively influencing the quality of the filtered water. A regeneration process becomes necessary if the filtration reservoir arrives at this state.

Hereinbelow, examples of the filtration sand cleansing system, which performs the steps of: extracting or suctioning out a portion of filtration sand; cleansing the extracted sand in a sand cleansing apparatus; retaining the cleansed sand, and returning the cleansed sand to a filtration reservoir; in addition to the conventional cleansing steps described above, will be described.

### Example 1

A sand cleansing apparatus as disclosed in U.S. Pat. No. 6,382,2212, which comprises: a cleansing tank for containing sand and cleansing water therein; a screw conveyor that rotates about a substantially perpendicular axis within the cleansing tank; a rotating means for rotating the screw conveyor at a speed so that: the rotation of the screw conveyor causes the sand and cleansing water to be elevated while contaminants are removed from the sand by contact between particles thereof with the cleansing water therebetween, at a lower portion of the screw conveyor which is beneath the surface of the cleansing water, and the rotation of the screw conveyor causes the sand to flow while contaminants are removed from the sand by contact between particles thereof with a slight amount of contaminant-laden water therebetween; and a circulation means for causing the elevated sand to descend to the lower portion of the screw conveyor so that the sand is elevated again, thereby realizing a scrubbing method of cleansing, was employed as the sand cleansing apparatus 3. As shown in FIG. 1 and FIG. 2, 1 m³ of contaminated filtration sand was suctioned out from a corner 1a of the filtration reservoir 1 by the pump 2, during the time 7 minutes˜10 minutes when surface cleansing and backwash cleansing was being performed. The suctioning of the filtration sand was performed at a depth of approximately 10 cm above the gravel layer 13, the filtration sand layer thickness being 60 cm. The filtration sand suctioned by the pump 2 was sent to the sand cleansing apparatus 3, and cleansing was performed for approximately one hour. As shown in Table 3, the degree of contamination of the suctioned filtration sand decreased to 11 degrees from 1480 degrees; the hydrochloric acid solubility decreased from 9.7% to 2.8%; and the uniformity coefficient was improved from 1.485 to 1.280. It can be understood that the filtration sand is returned to levels of new sand, by cleansing for approximately an hour.

TABLE 3

| | Contaminated | After Cleansing (minutes) | | | |
|---|---|---|---|---|---|
| | Sand | 10 | 20 | 30 | 60 |
| Contamination (degree) | 1,480 | 77 | 44 | 14 | 11 |
| Hydrochloric Acid Solubility | 9.7% | 7.7% | 4.3% | 3.5% | 2.8% |
| Effective Particle Diameter | 0.533 mm | 0.599 mm | 0.596 mm | 0.597 mm | 0.595 mm |
| Uniformity Coefficient | 1.485 | 1.287 | 1.284 | 1.284 | 1.280 |

The cleansed filtration sand was stored in a cleansed sand stock tank 4, containing water. Approximately 48 hours after filtration was recommenced at the filtration reservoir 1, filtration was ceased, and surface cleansing and backwash cleansing was performed again. During this time, the cleansed sand was returned to the filtration reservoir 1 at a corner 1b opposite the corner 1a from which the contaminated filtration sand was suctioned out. By repeating this cycle, substantially all 60 m³ of filtration sand in the filtration reservoir 1 was cleansed in approximately 120 days.

### Example 2

Filtration sand cleansing was performed in the same manner as Example 1 described above, except that the specific sand cleansing apparatus was replaced with a conventional jet water stream sand cleansing apparatus. As shown in Table 4, although there are slight significant differences between Example 1, which employed the specific sand cleansing apparatus, and Example 2, the contaminated sand was dramatically cleansed. In the case of Example 1, there was hardly any change in the effective particle diameter. However, in Example 2, as cleansing was performed for a long time, the effective particle diameter decreased, and the uniformity coefficient increased. It can be understood that in a conventional sand cleansing apparatus that employs a jet water stream, the sand collides with pipes, walls, and the like during cleansing, causing destruction thereof.

TABLE 4

| | Contaminated | After Cleansing (minutes) | | | |
|---|---|---|---|---|---|
| | Sand | 10 | 20 | 30 | 60 |
| Contamination (degree) | 1,480 | 208 | 173 | 167 | 88 |
| Hydrochloric Acid Solubility | 9.7% | 9.2% | 8.9% | 8.7% | 6.6% |
| Effective Particle Diameter | 0.533 mm | 0.606 mm | 0.603 mm | 0.590 mm | 0.577 mm |
| Uniformity Coefficient | 1.485 | 1.287 | 1.287 | 1.290 | 1.301 |

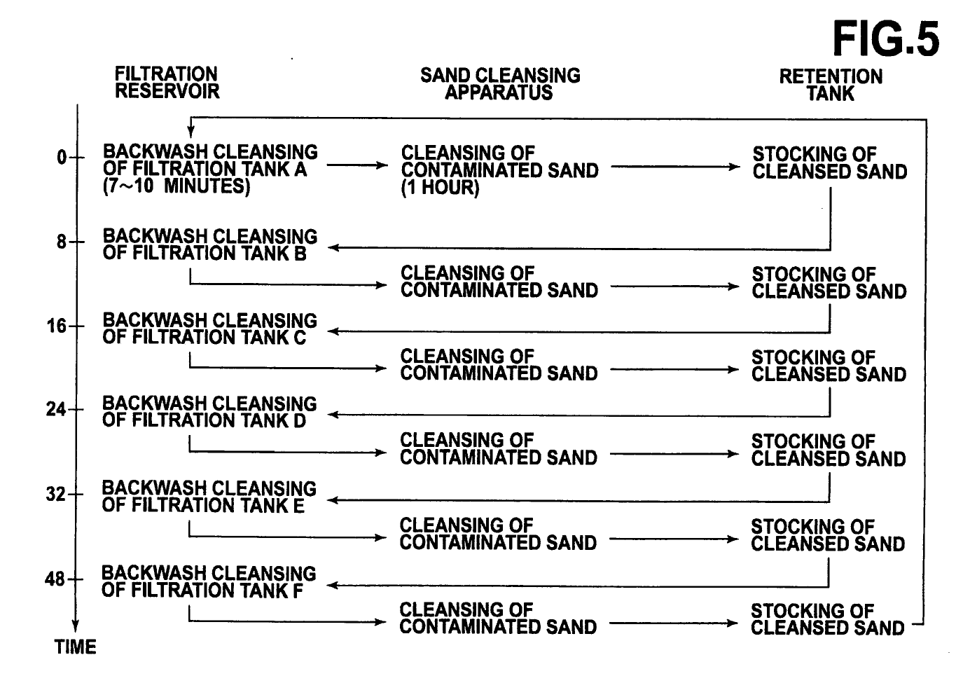

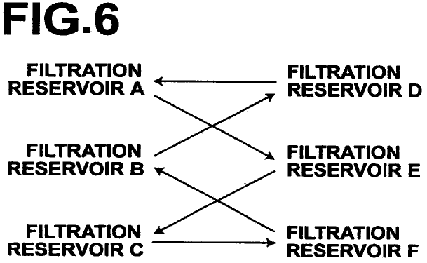

Next, a method and system for cleansing filtration sand in the case that a plurality of filtration reservoirs are provided will be described with reference to FIG. 5 and FIG. 6. FIG. 5 is a diagram showing the flow of filtration sand corresponding to a plurality of filtration reservoirs. FIG. 6 is a diagram that shows an example of the movement of filtration sand among filtration reservoirs. Here, a filtration sand system as shown in FIG. 5, comprising: six filtration reservoirs A through F; one sand cleansing apparatus; and one retention tank will be described as an example. However, the principle is exactly the same whether the number of filtration reservoirs is greater than or less than six.

Filtration reservoirs A through F are filtration reservoirs at which backwash cleansing is performed every 48 hours. As shown in FIG. 5, the intervals between the backwash cleansing of each of the filtration reservoirs is eight hours. First, a predetermined amount of filtration sand is suctioned out of filtration reservoir A. The suctioned filtration sand is cleansed for one hour in the sand cleansing apparatus. The filtration sand, from which contaminants have been removed, is retained in the retention tank, which contains water or water containing an oxidizing agent. The retained cleansed filtration sand is returned to filtration reservoir B, at which backwash cleansing is commenced eight hours after the backwash cleansing of filtration reservoir A. During the backwash cleansing of filtration reservoir B, contaminated filtration sand is suctioned out therefrom, while cleansed filtration sand is returned thereto. The filtration sand suctioned out from filtration reservoir B is cleansed for one hour by the sand cleansing apparatus, and the cleansed sand is retained in the retention tank, which contains water or water containing an oxidizing agent. The retained cleansed filtration sand is returned to filtration reservoir C, at which backwash cleansing is commenced eight hours after the backwash cleansing of filtration reservoir B. During the backwash cleansing of filtration reservoir C, contaminated filtration sand is suctioned out therefrom, while cleansed filtration sand is returned thereto. In this manner, when 48 hours pass, a predetermined amount of filtration sand is suctioned out from each of all of the filtration reservoirs A through F, and a predetermined amount of cleansed filtration sand is returned to each of all of the filtration reservoirs A trough F. By repeating these steps, all of the filtration sand of the filtration reservoirs A through F may be cleansed. By matching the extracting, cleansing, and returning steps to the timing of the backwash cleansing operations of a plurality of filtration reservoirs, filtration sand of a plurality of filtration reservoirs may be cleansed in substantially the same amount of time as that required for the cleansing of filtration sand of a single filtration reservoir.

In addition, in the case that the degree of contamination of the filtration sand increases in order from filtration reservoir A to filtration reservoir F: by returning the filtration sand, extracted from filtration reservoir A and cleansed, to filtration reservoir E; returning the filtration sand, extracted from filtration reservoir E and cleansed, to filtration reservoir C; returning the filtration sand, extracted from filtration reservoir C and cleansed, to filtration reservoir A; and so on as shown in FIG. 8, equalization of filtration sand among the filtration reservoirs A through F can be realized.

Further, by automatically performing at least the three steps of: suctioning out filtration sand from the filtration reservoir; cleansing the filtration sand with the sand cleansing apparatus; and returning the filtration sand, from which contaminants have been removed, to the filtration reservoir, or the four steps of: suctioning out filtration sand from the filtration reservoir; cleansing the filtration sand with the sand cleansing apparatus; retaining the cleansed filtration sand in the retention tank; and returning the filtration sand, from which contaminants have been removed, to the filtration reservoir, by sequence control, it becomes possible to maintain the filtration sand in a state similar to that of new sand for an extended period of time. Therefore, the time period between regeneration processes can be dramatically extended.

1-6. (canceled)

7. A system for cleansing filtration sand in a filtration reservoir embedded in the ground comprising:
a filtration reservoir totally or partially embedded in the ground;
a suctioning means for suctioning out filtration sand in an upward direction from the filtration reservoir;
a sand cleansing apparatus for cleansing the suctioned out filtration sand;
a retention tank for receiving the cleansed filtration sand from the sand cleansing apparatus and retaining the same,
a returning means for returning the same to the filtration reservoir during a backwash cleansing operation thereof.

8. A system for cleansing filtration sand as defined in claim 7, wherein:
the retention tank further comprises a means for supplying water to prevent the filtration sand within the retention tank from contacting air.

9. A system for cleansing filtration sand in a plurality of filtration reservoirs embedded in the ground comprising:
a plurality of filtration reservoirs;
a suctioning means for suctioning out a predetermined amount of filtration sand in an upward direction from one of the filtration reservoirs during a backwash cleansing operation of the first filtration reservoir;
a sand cleansing apparatus for cleansing the suctioned filtration sand;
a retention tank for receiving the cleansed filtration sand from the sand cleansing apparatus and retaining the same,
a returning means for returning the same to another filtration reservoir of the plurality of filtration reservoirs during a backwash cleansing operation of the second filtration reservoir.

10. A system for cleansing filtration sand as defined in claim 9, wherein:
the retention tank further comprises a means for supplying water to prevent the filtration sand within the retention tank from contacting air.
